(19) United States
(12) Patent Application Publication
(10) Pub. No.: US 2022/0363567 A1
(43) Pub. Date: Nov. 17, 2022

(54) Method to Remove and Concentrate PFAS from Water

(71) Applicant: Justin Bonn, Stoney Creek (CA)

(72) Inventors: Justin Andrew Bonn, Caistor Centre (CA); Richard Hamilton Nie, St. Catharines (CA); Kevin Grant Hall, New Market (CA)

(21) Appl. No.: 17/320,595

(22) Filed: May 14, 2021

(51) Int. Cl. C02F 1/24; C02F 1/44

(52) U.S. Cl. CPC C02F 1/24; C02F 1/441; C02F 1/442; C02F 1/444; C02F 2101/36

(57) ABSTRACT

Apparatus is disclosed for separating and concentrating one or more PFAS compounds from contaminated water or wastewater using a combination of membrane filtration and foam fractionation. Water is processed through a membrane filter to produce a permeate and a reject using a Reverse Osmosis or a Nanofiltration membrane where the permeate produced is suitable for potable applications and the reject produced is sent to a foam fractionator for further treatment. Wastewater is processed through a membrane filter to produce a permeate and a reject using an Ultrafiltration or Microfiltration membrane where the permeate produced is sent to a foam fractionator for further treatment and the reject is contained within a wastewater treatment plant as activated sludge. Membrane reject or permeate sent to a foam fractionator is then processed to remove any surface active contaminates (PFAS) by injecting air to generate a foam that can be collected and removed for storage producing a clean effluent that is suitable for environmental discharge and a foam concentrated with PFAS.

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### SEQUENCE LISTING

Not Applicable

### STATEMENT REGARDING PRIOR DISCLOSURES

Not Applicable

### BACKGROUND OF INVENTION

### Field of Invention

This invention relates to a method to separate and concentrate Per- and polyfluoroalkyl substances (PFAS) from water by using a combination of membrane technology and foam fractionation. Membrane technology can be used to treat water sources that are contaminated with PFAS where a produced permeate stream contains reduced levels of PFAS and a produced reject stream retains the majority of PFAS from the original water source. A foam fractionator can then be used to further isolate and concentrate PFAS contained in the membrane reject water stream to produce an effluent with reduced levels of PFAS and a foam with higher concentrations of PFAS. Additional foam fractionators can be used in series to further concentrate the foam containing PFAS. As required, effluent produced by the foam fractionators may flow through a final polishing step to reduce any residual PFAS prior to discharge, effluent may also be recirculated through the foam fractionators for a secondary pass and to blend with new reject or permeate.

### DESCRIPTION OF RELATED ART

Per- and polyfluoroalkyl substances (PFAS) are fluorinated compounds that are highly resistant to oil, water, temperature, chemicals, fire and electricity. PFAS is also exceptionally durable due of the strength of the carbon-fluorine bond and for this reason is deemed to be a forever chemical. PFAS compounds were introduced in the 1940's and used primarily for fire suppression foams and stain repellants, more recently, PFAS has evolved for use in electronic devices such as cell phones and is also used in food packaging to retain grease. Exposure to PFAS is associated with high cholesterol, increased liver enzymes, decreased vaccination response, thyroid disorders, pregnancy induced hypertension and preeclampsia, cancer, immune suppression, reduced fertility and fecundity. In humans, PFAS contaminated food intake has been found to be the primary exposure pathway for adults while dust and dietary ingestion are for children. Drinking water is considered to be a major exposure pathway in communities with contaminated water sources. The effects of PFAS in the human body are bio accumulative and were detected in the bloodstream of 99% of the United States general population tested between 1999 and 2012. In 2006 the Environmental Protection Agency (EPA) began the PFOA stewardship program which worked with eight leading PFAS manufacturers to achieve PFAS compound reductions. In 2009 the first provisional health advisories for PFOS and PFOA were issued by the EPA who finalized a drinking water health advisory limit of 70 ng/L for PFOS and PFOA both individually and combined. In 2020 the EPA issued a press release confirming that the National Pollutant Discharge Elimination System (NPDES) is planning to include PFAS related conditions in new wastewater treatment permits. In 2021 the EPA issued a press release confirming their intent to repropose the Fifth Unregulated Contaminant Monitoring Rule (UCMR5) to collect new data on PFAS in drinking water to improve the EPA's understanding of the frequency that 29 PFAS compounds are found in the nations drinking water systems and at what levels. As of this writing, the EPA has authorized four treatment methods to remove PFAS from drinking water, these include Granular Activated Carbon (GAC), Powdered Activated Carbon (PAC), Ion Exchange Resins (IXR), Nanofiltration (NF) and Reverse Osmosis (RO) membranes. GAC, PAC and IXR treatment solutions work well however they come with large operational expense as the media needs to be changed frequently and incinerated for proper disposal. NF and RO treatment solutions work well at separating PFAS from drinking water however these systems produce large quantities of reject or concentrate streams that are unable to capture and retain PFAS without additional treatment equipment.

Membrane filtration is used extensively in water and wastewater treatment with equipment configurations selected based on their separation mechanisms and the desired size of separated particles. Reverse Osmosis (RO) and Nanofiltration (NF) membranes are effective at filtering PFAS from raw water sources while Ultrafiltration (UF) and Microfiltration (MF) membranes are unable to remove PFAS to their larger pore structure. Membrane filters traditionally function with a raw water supply that is processed using a pressure differential across the membrane surface to extract a desirable permeate and a reject stream of concentrate. In a municipal water treatment setting where the raw water supply has been contaminated by PFAS, RO & NF permeate streams will produce potable water with a reject stream that retains elevated concentrations of PFAS which are typically discharged to the environment or sent to a wastewater treatment system for further treatment. In a municipal wastewater treatment setting where the raw wastewater influent has been contaminated by PFAS, UF & MF permeate streams will produce an effluent containing PFAS that would traditionally be discharged to the environment and when activated sludge is wasted from these systems, PFAS would also be present in the wasted sludge.

Foam Fractionation is a chemical process in which hydrophobic molecules are separated from liquids using rising columns of foam, this technology is commonly employed to remove organic surface-active contaminants from wastewater streams however it is also effective at removing inorganic surface-active contaminates. PFAS compounds are inorganic surface-active contaminants as they consist of hydrophobic heads and hydrophobic tails, it is for this reason that they are attracted to interfaces of air/water and can be collected using a foam fractionator. A foam fractionator works by allowing water contaminated with PFAS to enter the upper portion of the fractionator and to exit down through the bottom. As the liquids travel down and through the body, the water is stripped of surface-active contaminants by the bubbles injected at the base which then rise to the surface. Smaller bubbles are more effective when used in the foam fractionation process due to an increase in surface area while occupying the same volume as larger bubbles. As bubbles start to collect on the surface, they become denser as water begins to drain developing a foam that can be easily removed with a vacuum or skimmer.

### SUMMARY OF INVENTION

Water contaminated with PFAS can be expensive to treat when using adsorption media, the EPA has also approved Reverse Osmosis (RO) and Nanofiltration (NF) as a means to produce potable water however concentrate streams generated by membranes can lead to further environmental contamination. Due to the molecular structure of PFAS having a hydrophilic head and a hydrophobic tail, foam fractionation can be employed as a means to efficiently separate and collect PFAS from water. When combining RO & NF technology with foam fractionation PFAS is efficiently removed by the membranes and collected/concentrated by the foam fractionators resulting in a clean permeate suitable for human consumption and a reject stream that is processed into a clean effluent with low contaminant levels suitable for environmental discharge and a foam with high concentrations of PFAS that can be efficiently disposed.

### DRAWING DESCRIPTION

FIG. 1 shows a general arrangement of the treatment process claimed.

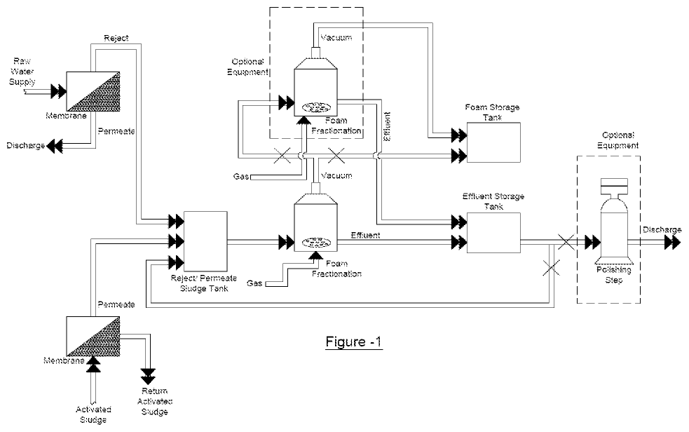

### DETAILED DESCRIPTION OF THE INVENTION

When an environment is contaminated with PFAS, these compounds will migrate into sources of water and when ingested will accumulate in the body resulting in poor human health. In drinking water systems, the use of adsorption media is generally viewed to be the preferred method of PFAS removal and collection however this approach comes with a high operational cost due to frequent media changes and disposal costs (incineration). Membrane filtration (RO & NF) is also effective at separating PFAS from drinking water however the subsequent concentrate or reject waste streams ultimately lead to further contamination of the surrounding environment unless treated with additional equipment. Due to the hydrophilic/hydrophobic structure of PFAS molecules, foam fractionation is an effective means of collecting PFAS from water however it is not currently approved by the EPA as a means of treating PFAS from drinking water systems. When combining membrane technology with foam fractionation, PFAS levels in drinking water can be reduced to acceptable levels for human health, reject streams can be treated for PFAS removal without the use of consumable media effectively reducing environmental contamination and operational expenses. In areas where PFAS contamination requires higher levels of removal to meet discharge limits, an additional polishing step may be employed to further limit contamination by way of adsorption media, electro-oxidation, electro-reduction, advanced oxidative processes, and plasma reactors. Additional foam fractionators may also be used to achieve higher concentrations of PFAS effectively reducing the cost for disposal. PFAS remediation may also take place at a wastewater treatment plant where membrane technology produces a permeate that is sent to one or more foam fractionators for treatment prior to discharge or reuse.

### SEQUENCE LISTING

Not Applicable

1. A method for the decontamination of water or wastewater containing one or more PFAS compounds using a primary membrane filter to produce a reject or permeate that passes through a secondary foam fractionator to produce a foam and an effluent.

2. The method of claim 1 wherein a Reverse Osmosis or Nanofiltration membrane produces a permeate that is suitable for discharge or consumption and a reject that is sent to a foam fractionator.

3. The method of claim 1 wherein an Ultrafiltration or Microfiltration membrane produces a permeate that is sent to a foam fractionator and a reject that is used as an activated sludge.

4. The method of claim 1 wherein the foam produced consists of PFAS compounds that can be further concentrated by processing the foam in additional foam fractionators.

5. The method of claim 1 wherein the effluent produced by the foam fractionator can be discharged to the environment or reused for other applications.

6. The method of claim 5 wherein the effluent can be further polished of residual contaminants by using adsorption media, electro-oxidation, electro-reduction, advanced oxidative processes, and plasma reactors to achieve a higher quality effluent.
